(19) United States
(12) Patent Application Publication
(10) Pub. No.: US 2010/0215515 A1
(43) Pub. Date: Aug. 26, 2010

(54) Pump unit as well as a pump and a discharge connection

(75) Inventor: Patrik Andersson, Skogas (SE)

Correspondence Address: BROWDY AND NEIMARK, P.L.L.C.;624 NINTH STREET, NW, SUITE 300, WASHINGTON, DC, 20001-5303, US

(73) Assignee: ITT Manufacturing Enterprises, Inc., Wilmington, DE (US)

(21) Appl. No.: 11/917,122

(22) PCT Filed: Jun. 5, 2006
(86) PCT No.: PCT/SE06/00659

§ 371 Date: Dec. 1, 2009

(30) Foreign Application Priority Data
Jun. 10, 2005 (SE) 0501326-3

(51) Int. Cl. F04B 39/00; F16C 11/04

(52) U.S. Cl. 417/312; 403/220

(57) ABSTRACT

In a first aspect the invention relates to a pump unit comprising a discharge connection (3) and a pump, the pump comprising a pump housing (7), and a claw (6) connectable to the pump housing (7), the pump unit having at least two contact interfaces, a first contact interface between an outlet of the pump housing (7) and an inlet of the discharge connection (3) and a second contact interface between the claw (6) and the exterior of the discharge connection (3). Furthermore, the at least one energy absorbing element (8, 9) is disposed at, at least, one of the contact interfaces, and wherein the pump and the discharge connection. (3) at said at least one contact interface are spaced apart by means of said energy absorbing element (8, 9). The invention also relates to a pump and a discharge connection (3).

### TECHNICAL FIELD OF THE INVENTION

The present invention relates generally to the field of pumping stations for sewage or waste water, and more specifically to a pump unit comprising a discharge connection and a pump. The pump comprises a pump housing and a claw connectable to the pump housing. Said pump unit has at least two contact interfaces, a first contact interface between an outlet of the pump housing and an inlet of the discharge connection and a second contact interface between the claw and the exterior of the discharge connection.

The invention also relates to a pump and a discharge connection.

### BACKGROUND OF THE INVENTION

In recent years the weight of submergible pumps for pumping water and/or more or less liquid waste from out of sewage stations, septic tanks or wells, have decreased as a result of a change in material used and a new and more slender design of the pumps. This reduction of weight is advantageous regarding the size of the production equipment, transportation capacity, manufacturing costs, material costs, etc., but new and unexpected disadvantages have appeared.

Typically, submergible pumps are used to pump fluid from basins that are hard to get access to and/or basins comprising excrement or the like into which the pump is sub-merged. Therefore it is highly desirable to provide a pump unit needing maintenance more seldom, i.e. a pump unit having long durability. However, due to the weight reduction, pumps tend to vibrate during operation at an extent considerably exceeding allowed limits. The vibrations increase the risk that the pump unit will malfunction more often, and will thus need maintenance more often. Furthermore, auxiliary equipment, such as piping and electronic components risk to be damaged. Pumps of earlier design were too heavy to vibrate due to their own weight and therefore the above mentioned disadvantage has not appeared earlier. One solution is to add weight to the pump, but this is not a useful solution since the basic object of the redesign work has been to reduce the weight of the pump. The vibrations adversely affects the pump unit, which needs maintenance more often than pump units haying the earlier design, since piping, electronic components, the pump and the discharge connection are more prone to breakage. Thus, the operation of the pump unit is not guaranteed to the desired extent and any down periods that may arise are costly.

U.S. Pat. No. 3,880,553 discloses a pump unit comprising a pump and a discharge connection, the pump having two claws forming a first contact interface with the exterior of the discharge connection, and an outlet forming a contact interface with an inlet of the discharge connection. In order to solve the generation of vibrations during operation of the pump unit, the two claws are greatly separated to create as long distances as possible between the contact points. In the contact interface between the outlet of the pump and the inlet of the discharge connection a sealing gasket is provided to prevent leakage. The pump and the discharge connection are still in full contact with each other at said contact interfaces. A problem with the pump unit, shown in U.S. Pat. No. 3,880,553, is that the pump and the discharge connection both have to be fairly modified to present an adequate distance between the claws and the corresponding coupling parts of the discharge connection. The vibrations will nevertheless adversely affect the gasket, since said gasket has neither the design nor the material to absorb vibrations, with the consequence of water leaking out.

US 2004/0197207 discloses a pump unit comprising an elbow pipe and a pump. The pump comprises a pump housing and a claw which is connectable to the pump housing, the pump unit having at least two contact interfaces, a first contact interface between an outlet of the pump housing and an inlet of the elbow pipe and a second contact interface between the claw and the exterior of the elbow pipe. The pump unit of US 2004/0197207 makes use of a gasket positioned at the contact interface between the outlet of the pump and the inlet of the elbow pipe in order to prevent leakage between the pump and the discharge connection, but without separating the pump and the elbow pipe from each other. The fact that the pump and the elbow pipe are allowed to turn and move in relation to each other in any direction without obstructing influence from the gasket, further indicate that the gasket does not have the shape or purpose of damping vibrations of the pump unit during operation of the pump.

At present, there are no pump units that have anti vibration or energy absorbing arrangements working satisfactory.

### SUMMARY OF THE INVENTION

The present invention aims at obviating the aforementioned disadvantages of previously known pump units, and at providing an improved pump unit. A primary object of the present invention is to provide an improved pump unit of the initially defined type with respect to the ability of reducing/preventing vibrations during operation. It is another object of the present invention to provide a pump unit comprising conventionally available pumps and discharge connections and without any need of drastic redesign of such pumps and discharge connections. It is yet another object of the present invention to provide a pump unit having an improved durability. It is another object of the invention to provide a pump unit, in which an angular displacement between the discharge connection and, on one hand, the pump housing and, on the other hand, the claw is absorb, in order to prevent leakage at the contact interface between the pump housing and the discharge connection.

According to the invention at least the primary object is attained by means of the initially defined pump unit, a pump and a discharge connection having the features defined in the independent claims. Preferred. embodiments of the present invention are further defined in the dependent claims.

According to a first aspect of the present invention, there is provided a pump unit of the initially defined type, which is characterized in that at least one energy absorbing element is disposed at, at least, one of the contact interfaces, and wherein the pump and the discharge connection at said at least one contact interface are spaced apart by means of said energy absorbing element.

According to a second aspect of the present invention, there is provided a pump according to claim 15.

According to a third aspect of the present invention, there is provided a discharge connection according to claim 16.

Thus, the present invention is based on the insight of utilizing energy absorbing elements for damping/reducing the vibrations and of providing said energy absorbing elements at contact interfaces between the pump and the discharge connection, which are particularly important for the generation of said vibrations.

In a preferred embodiment of the present invention, the energy absorbing element of the pump unit comprises a resilient rubber plate, said rubber plate being fixed to two support elements, and the whole element being connectable to the pump. This means that maintenance of the energy absorbing element may easily be carried out, or the element may easily be replaced at the same time as the pump is brought to ground level and given service.

According to a preferred embodiment, one energy absorbing element is disposed at each contact interface of the pump unit. Then there are no direct contact between the pump and the discharge connection at all, the risk of transporting vibrations from the pump to the discharge connection thereby being reduced radically.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a side elevational view of a pump unit according to the present invention during set up, i.e. while the pump is lowered towards the discharge connection,

FIG. 2 is a side view of the pump unit shown in FIG. 1, while the set up is completed,

FIG. 3 is an enlarged cross sectional view of selected items of the pump unit shown in FIG. 2, showing the discharge connection, the pump and the energy absorbing element,

FIG. 4 is a further enlarged cross sectional view of the pump unit shown in FIG. 3,

FIG. 5 is a cross sectional side view of a pump, comprising a pump housing and a claw,

FIG. 6 is a cross sectional view of a discharge connection,

FIG. 7 is a cross sectional side view of a preferred embodiment of the energy absorbing element,

FIG. 8 is a perspective view of the energy absorbing element shown in FIG. 7, and

FIG. 9 is a diagram showing the vibration of a pump unit provided with damping means and of a pump unit without damping means at different liquid flows.

### DETAILED DESCRIPTION OF PREFERRED EMBODIMENTS OF THE INVENTION

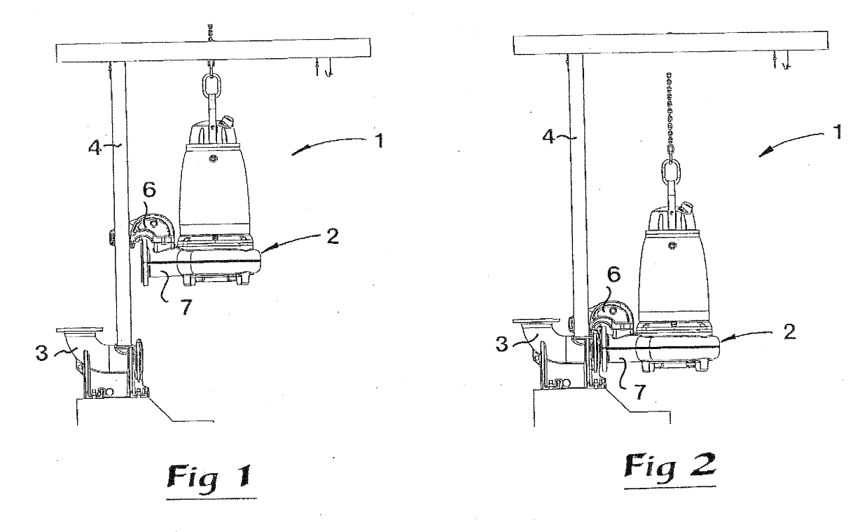

With reference to FIGS. 1 and 2, there is shown a pump unit 1 according to the present invention, which may constitute one unit, out of many, in a pumping station for a sewage system or the like. The pump unit 1 comprises a pump 2, preferably a submergible pump, and a discharge connection 3. The pump unit 1 is arranged to pump liquid waste, sewage, water, etc., out of e.g. a sewage station. During operation the pump 2 and the discharge connection 3 are located wholly or partly under the liquid surface. From the discharge connection 3 there is a pressure pipe (not shown) extending upwards and further away to some suitable location distanced from the pump unit 1, e.g. a sewage treatment plant.

Due to the unpleasant or even toxic nature of the liquid waste in sewage systems, conventional pump units are design to be operated from ground level during set up and removal of the pump 2. The discharge connection 3 is fixed to the bottom of the system with guide rails 4 extending upwards to ground level. In the shown embodiment the pump unit 1 comprises a pair of parallel guide rails 4, only one of which is seen. The guide rails 4 are connectable to the discharge connection 3 by being applied to the peg 5 shown, e.g. in FIG. 6. During set up, the pump is lowered guided by a claw 6, or guiding/holding claw, which runs along the guide rails 4. The guiding claw 6 is design to be able to run only in the vertical direction between the guide rails 4, and encloses each guide rail 4 on at least three sides in the shown embodiment. The claw 6 is connectable to a pump housing 7 of the pump 2, which pump housing 7 comprises an impeller (not shown). When the pump 2 is lowered the guiding claw 6 finally abuts the exterior, or the top, of the discharge connection 3, whereupon. an outlet of the pump housing 7 abuts an inlet of the discharge connection 3.

The pump unit 1 has at least two contact interfaces, a first contact interface between the outlet of the pump housing 7 and the inlet of the discharge connection 3 and a second contact interface between the claw 6 and the exterior of the discharge connection 3. Said second contact interface also constitutes a suspension point for the pump 2, i.e. the pump 2 is suspended in the guiding/holding claw 6 on top of the discharge connection 3 and the pump 2 is held in place at the discharge connection 3 by its own weight. The pump 2 is swung downwards by its own weight around said second contact interface, the outlet of the pump housing 7 and the inlet of the discharge connection 3, or more precisely the rims thereof, being pressed. against each other. It shall be pointed. out that the terms outlet and inlet, herein. means the contact surfaces of the structural walls, or flanges, surrounding the actual outlet and inlet, respectively.

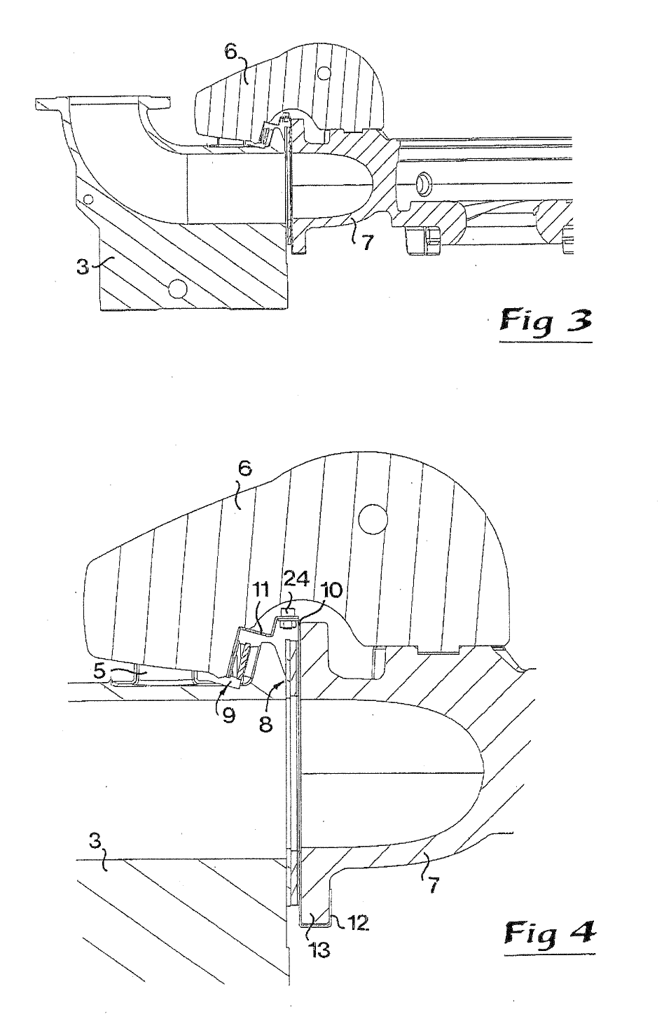

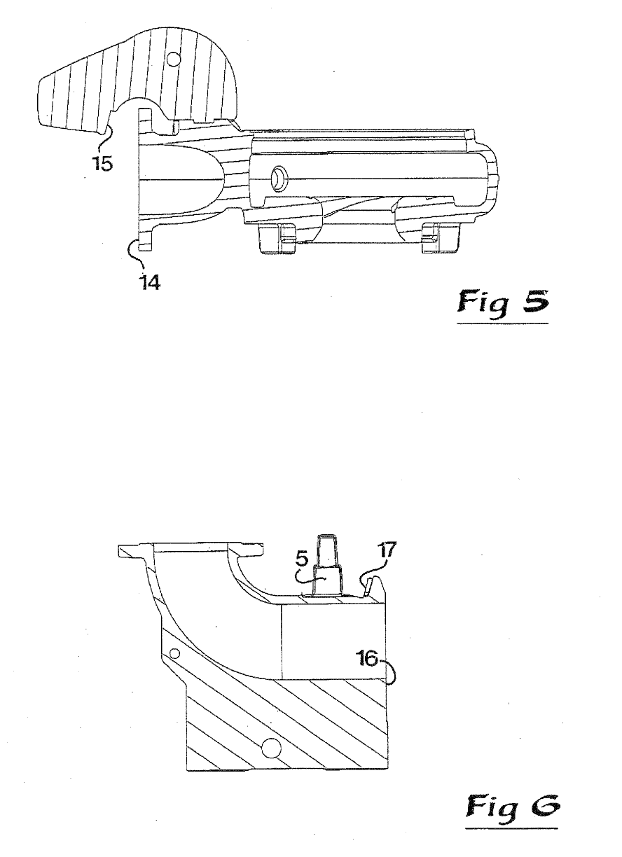

Reference is now made to FIGS. 3 and 4. It is shown enlarged. cross sectional views of the inventive pump unit 1. The guiding claw 6 is connected to the top of the pump housing 7 by fastenings means (not shown), such as bolts, clamps or the like. It shall be pointed out that the claw 6 also may be formed integrally with the pump housing 7. In the shown preferred embodiment of the pump unit 1 according to the present invention, an energy absorbing element 8, 9 is disposed at each of the two contact interfaces of the pump unit 1. The first energy absorbing element 8 is disposed between the outlet of the pump housing 7 and the inlet of the discharge connection 3, and the second. energy absorbing element 9 is disposed between the claw 6 and the exterior of the discharge connection 3. In the shown embodiment said two energy absorbing elements 8, 9 are connected to each other by means of two brackets 10, 11. Said two brackets 10, 11 are connected to each other by fastenings means 24, and the bracket 11 associated with the second energy absorbing element 9 is connected to the claw 6 by fastening means (not shown), such as bolts or the like. The bracket 10 associated with the first energy absorbing element 8 is connected. to the pump housing 7 by a U-shaped hook 12. Said hook 12 is arranged to grip around the flange 13 connected to and surrounding the outlet of the pump housing 7. No further fastening means are used in the shown embodiment. It shall be pointed out that said two brackets 10, 11 may be formed integrally, and that the hook 12 preferably is an integral part of the bracket 10.

According to other embodiments of the invention, there is only one energy absorbing element 8, 9 disposed at only one of said contact interfaces, either between the outlet of the pump housing 7 and the inlet of the discharge connection 3 or between the claw 6 and the exterior of the discharge connection 3. When only one energy absorbing element 8, 9 is used; said brackets 10, 11 are not necessarily needed. However, it-shall be pointed out that the brackets 10, 11 are not essential even when two energy absorbing elements 8, 9 are used. In that case said energy absorbing elements 8, 9 are connected to the outlet of the pump housing 7 and the claw 6, respectively, by fastening means such as bolts. Accordingly, in that case intermediate brackets are not needed. However; it shall also be pointed out that said energy absorbing elements 8, 9 together with associated brackets 10, 11 may be connected to the discharge connection 3 by fastening means, instead of to the pump 2. It is nevertheless preferable to connect the energy absorbing elements 8, 9 to the pump 2, since the discharge, connection 3 is more or less fixed to the bottom of the well. However, the pump 2 may be hoisted to ground level for maintenance, in which case the hoisting is operated from ground level. Thus, the energy absorbing elements 8, 9 may be maintained at the same time as the pump 2.

Reference is now made to FIGS. 5 and 6. In FIG. 5 there is shown a pump 2 comprising a pump housing 7 and a guiding claw 6 and in FIG. 6 there is shown a discharge connection 3. Said pump 2 has at least two contact surfaces 14, 15 arranged to abut against at least two contact surfaces 16, 17 of said discharge connection 3. The first contact surface 14 of the pump 2 is at the outlet of the pump housing 7 and the second contact surface 15 of the pump 2 is at the claw 6. Accordingly the first contact surface 16 of the discharge connection. 3 is at the inlet of said discharge connection 3 and the second contact surface 17 of the discharge connection 3 is at the exterior of said discharge connection 3.

When an energy absorbing element 8, 9 is connected to any of the abovementioned contact surfaces 14, 15, 16, 17, said energy absorbing element 8, 9 forms the contact surface against the corresponding contact surface instead of the contact surface 14, 15, 16, 17, which said energy absorbing element 8, 9 is connected to. Thus, the pump 2 and the discharge connection 3 are spaced apart by means of the energy absorbing element 8, 9 at that contact interface at which. said energy absorbing element 8, 9 is disposed.

It shall be pointed out that the at least one energy absorbing element 8, 9 is connected to at least one of abovementioned contact surfaces 14, 15, 16, 17, during operation.

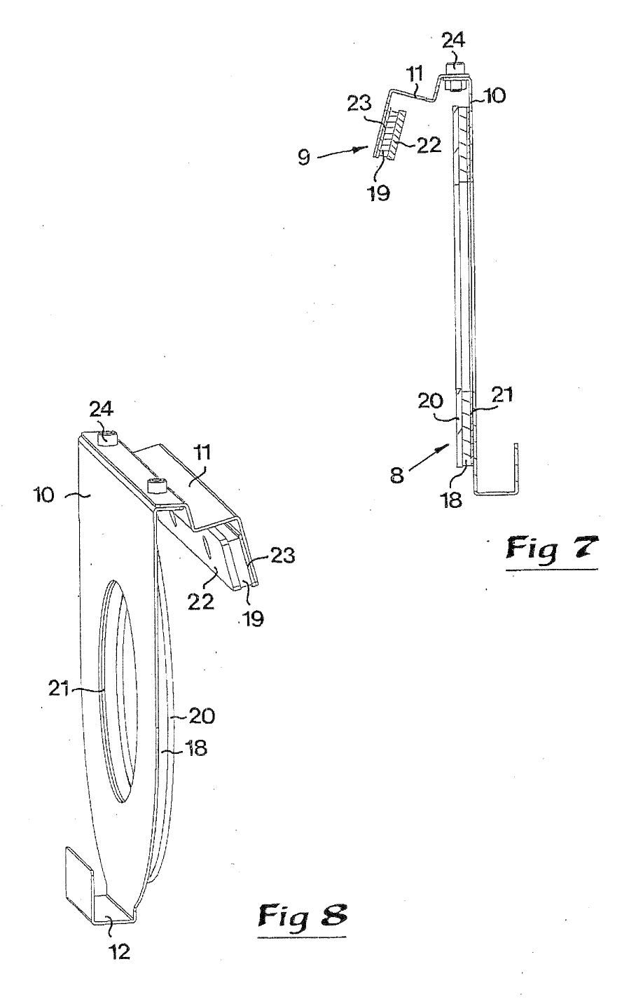

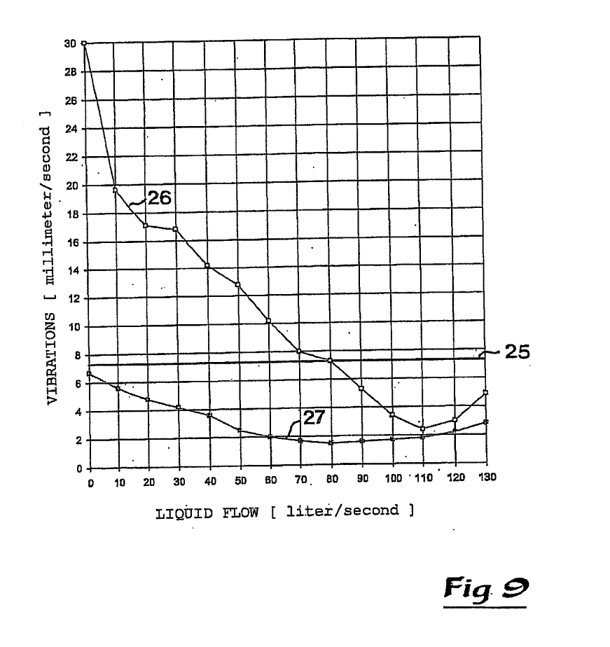

Reference is now made to FIGS. 7 and 8. It is shown two energy absorbing elements 8, 9 connected to each other by two brackets 10, 11. Each energy absorbing element 8, 9 comprises means 18, 19 for damping, reducing or preventing the vibrations of the pump unit 1 during operation. In a preferred embodiment said damping means 18, 19 are resilient. In a more preferred embodiment said damping means 18, 19 of said energy absorbing element 8, 9 is made out of rubber. The rubber is preferably, but not necessarily, in the shape of a plate. In the shown. embodiment the first rubber plate 18 is shaped like a washer, the through hole of which has about the same diameter as the outlet opening of the pump housing 7 and the inlet opening of the discharge connection 3. However, said openings do not have to present the same diameter and does not have to present a circular shape, although it is preferable. The second rubber plate 19 has a rectangular shape. Said second damping means 19 may be constituted out of one or more discrete members, which are adjacent or spaced apart along the width of the second energy absorbing element 9. However, the first damping means 18 should be continuous all the way around the through hole, in order to be leakproof and additionally act as a sealing. Furthermore, the damping means 18, 19 can absorb an angular displacement between the outlet of the pump housing 7 and the inlet of the discharge connection 3, and still more improve the leakproofness of the pump unit 1. In other words the manufacturing tolerance of the pump housing and the discharge connection may be broadened and by that the manufacturing costs will decrease. Each rubber plate 18, 19 are fixed to two opposite support elements 20, 21 and 22, 23, respectively. Preferably the rubber plates 18, 19 are vulcanized or glued to said support elements 20, 21, 22, 23. In the shown embodiment each of said units 20, 21, 22, 23, is constituted by a discrete plate, preferably a metal plate. In that case each energy absorbing element 8, 9, comprising said damping means 18 and 19, respectively, and said discrete plates 20, 21 and 22, 23, respectively, are connected to the abovementioned brackets 10, 11 or directly to the corresponding abovementioned contact surfaces 14, 15, 16, 17. The discrete plates 20, 21 associated with the first energy absorbing element 8 each has a through hole having a diameter of about the same size as the abovementioned rubber plate 18. If the bracket 10 associated with the first energy absorbing element 8 is used, it has also a through hole corresponding to the through holes of the rubber plate 18 and the discrete plates 20, 21. All the abovementioned through holes have approximately the same contre axis.

Reference is now only made to the first energy absorbing element 8 and the pump housing 7, even though the description below also apply to any feasible combination of the first energy absorbing element 8 and the second energy absorbing element 9 together with the pump 2 and the discharge connection 3. Thus, in another embodiment of the present invention one of said two support elements that the rubber plate 18 is fixed to, may be constituted by the contact surface 14 of the pump housing 7. That is, the rubber plate 18 is fixed to, or preferably vulcanized to, on one hand, the discrete plate 20 and, on the other hand, the contact surface 14 of the pump housing 7. Thus, in that case the energy absorbing element 8 will be an integral part of the pump 2.

The only modification that is needed on conventional pumps 2 and/or discharge connections 3 upon implementation of the present invention, is that one or more of the contact surfaces 14, 15, 16, 17 have to be machined, e.g. by face milling, in an extent equal to the thickness of the corresponding energy absorbing element 8, 9.

Reference is now made to FIG. 9 which is a diagram showing the results from a test in which two pump units where operated at a constant frequency 60 Hz and at different liquid flows, the vibration of the pump units being measured. An upper allowed boundary 25 for the vibrations is shown at approximately 7.1 mm/s. The upper graph 26 shows the results of a pump unit without anti vibration or energy absorbing elements 8, 9 end the lower graph. 27 shows the results of a pump unit provided with energy absorbing elements 8, 9 at both contact interfaces between the pump 2 and the discharge connection 3.

### Feasible Modifications of the Invention

The invention is not limited only to the embodiments described above and shown in the drawings. Thus, the pump unit as well as the pump and the discharge connection may be modified in all kinds of ways within the scope of the appended claims. For instance, the damping means may be constituted by one or more metal springs in combination with a sealing gasket. Furthermore, said second contact interface may be constituted by one or more discrete contact points and the second energy absorbing element may be constituted by several discrete energy absorbing elements which are spaced apart from each other.

It shall also be pointed out that even though the term “energy absorbing element”, for sake of simplicity, has been used in the claims as well as in the description, it shall be realized that also other types of anti vibration elements are included, such as elements moving the natural frequency of the pump unit outside the range of operation of the pump unit.

1. A pump unit (1) comprising a discharge connection (3) and a pump (2), the pump (2) comprising a pump housing (7), and a claw (6) connectable to the pump housing (7), the pump unit (1) having at least two contact interfaces, a first contact interface between an outlet of the pump housing (7) and an inlet of the discharge connection (3) and a second contact interface between the claw (6) and the exterior of the discharge connection (3), characterized in that at least one energy absorbing element (8, 9) is disposed at, at least, one of the contact interfaces, and that said energy absorbing element (8, 9) comprises means (18, 19) for damping the vibrations of the pump unit (1) during operation, and wherein the pump (2) and the discharge connection (3) at said at least one contact interface are spaced apart by means of said energy absorbing element (8, 9).

2. A pump unit according to claim 1, wherein said damping means (18, 19) is resilient.

3. A pump unit according to claim 1, wherein one energy absorbing element (8, 9) is disposed at each contact interface of the pump unit (1).

4. A pump unit according to claim 1, wherein said at least one contact interface is said first contact interface.

5. A pump unit according to claim 1, wherein said at least one contact interface is said second contact interface.

6. A pump unit according to claim 1, wherein said damping means of said energy absorbing element (8, 9) is made out of rubber.

7. A pump unit according to claim 6, wherein said damping means is in the shape of a rubber plate (18, 19) connected to two support elements (20, 21, 22, 23) provided on opposite sides thereof.

8. A pump unit according to claim 7, wherein one of said units (21, 23) is constituted by a contact surface of the pump (2) and the other one of a discrete plate (20, 22).

9. A pump unit according to claim 7, wherein one of said units (20, 22) is constituted by a contact surface of the discharge connection (3) and the other one of a discrete plate (21, 23).

10. A pump unit according to claim 7, wherein each of said two support elements is constituted by a discrete plate (20, 21, 22, 23).

11. A pump unit according to claim 7, wherein said two support elements are spaced apart by said rubber plate (18, 19).

12. A pump unit according to claim 9, wherein said energy absorbing element (8, 9) is connectable to the pump (2) by fastening means.

13. A pump unit according to claim 9, wherein said energy absorbing element (8, 9) is connectable to the discharge connection (3) by fastening means.

14. A pump (2) comprising a pump housing (7), and a claw (6) connectable to the pump housing (7), the pump (2) having at least two contact surfaces (14, 15) arranged to abut against corresponding contact surfaces (16, 17) of a discharge connection (3), a first contact surface (14) being at an outlet of the pump housing (7) and a second contact surface (15) at the claw (6), characterized in that at least one energy absorbing element (8, 9) is connectable to, at least, one of the contact surfaces (14, 15) of the pump (2), and wherein said energy absorbing element (8, 9) thereby forms the contact surface against the discharge connection (3) instead of said at least one contact surface (14, 15) of the pump (2), and that said energy absorbing element (8, 9) comprises means (18, 19) for damping the vibrations of the pump unit (1) during operation.

15. A discharge connection (3) having at least two contact surfaces (16, 17) arranged to abut against corresponding contact surfaces (14, 15) of a pump (2) comprising a pump housing (7) and a claw (6) connectable to the pump housing (7), a first contact surface (16) being at an inlet of the discharge connection (3) and a second contact surface (17) at the exterior of the discharge connection (3), characterized in that at least one energy absorbing element (8, 9) is connectable to, at least, one of the contact surfaces (16, 17) of the discharge connection (3), and wherein said energy absorbing element (8, 9) thereby forms the contact surface against the pump (2) instead of said at least one contact surface (16, 17) of the discharge connection (3), and that said energy absorbing element (8, 9) comprises means (18, 19) for damping the vibrations of the pump unit (1) during operation.
